(19) United States
(12) Patent Application Publication
(10) Pub. No.: US 2008/0272919 A1
(43) Pub. Date: Nov. 6, 2008

(54) ELECTRONIC LOCATOR

(76) Inventors: EDWARD G. NEWMAN, Fairfax, VA (US); BENJAMIN P. NEWMAN, Fairfax, VA (US); RICHARD BIZAR, Fairfax, VA (US); HSIAO PENG, Lorton, VA (US)

Correspondence Address: Law Offices of James J. Ralabate, 5792 Main St., Williamsville, NY, 14221, US

(21) Appl. No.: 12/137,886

(22) Filed: Jun. 12, 2008

Related U.S. Application Data
(63) Continuation-in-part of application No. 11/229,876, filed on Sep. 19, 2005.

(51) Int. Cl. G08B 23/00

(52) U.S. Cl. 340/573.1

(57) ABSTRACT

This provides a system to emit a plurality of electronic signals, sent by a person(s) trapped by some disaster, such as collapse of building, earthquake, flood, etc. The plurality of four signals in addition to cell phones and computers provides a better chance that rescuers will receive at least one signal.

This invention relates to a locator device and, more specifically, to an electronic transmitter device that is enabled to be used in an emergency to locate individuals requiring emergency assistance, and/or in non-emergencies to control local and remote environments. This application is a Continuation-in-Part of application Ser. No. 11/229,876 filed in the US Patent Office on Sep. 17, 2005.

### BACKGROUND

When people are trapped as a result of fire, coal mine collapse, terrorist attack or natural disaster, it is important that they have some means to alert rescue teams of their location. If means were available to stranded or trapped people, their rescue could be greatly facilitated if the rescuers were aware of their location. Recent assaults on the USA and natural disasters have demonstrated a critical need for individuals to be able to communicate with and/or provide their location to others including emergency rescue staff, police, firemen and others, under extremely stressful conditions, both environmentally and psychologically. There are currently no practical methodologies, means or devices which permit this “automatic” location of individuals, nor that facilitate their ability to communicate their location and/or condition to others. The inability to communicate either by speech, digital text or preprogrammed messages, including location data, or other digital data, in the immediate area (up to 500 yards, or more) is further compounded when the individual is beneath the ground, in interior spaces with concrete and/or metal walls, or under rubble or trapped in submersibles and/or mines.

### SUMMARY

The present embodiments provide an information appliance or an electronic locator device that can communicate the location of its user to others by emitting several means of communication sequentially and/or communicate other information with other individuals or devices or structures. Often rescue teams have only one or two receivers such as a computer or a cell phone or push-to-talk communicators to receive messages; if the person trapped has no computer or cell phone, it is impossible to direct the rescuers to the trapped location. The present invention provides a transmitter or electronic locator that emits at least four, but preferably in addition to cell phone and computer a plurality of at least four different signals that increase the chances at least one signal will handshake or be received by the rescue team or other desired targets of communication. By “several” and “plurality” is meant six or more signals.

Signals that are emitted sequentially by the electronic locator device include, in addition to a computer and cell phone, at least four signal members selected from the group consisting of: AM radio, FM radio, XM radio, cellular mobile computers, GSM phones, microwave, sonar, satellite line-of-site, IEEE 802.11X communications standards and Infrared. Police, firemen or other rescuers are more likely to have one of these signal receivers which increases the probability of the trapped person being rescued. If rescuers did not have a cell phone, there is a high probability that one of these other at least four signals could be received by them.

While it is desirable for the portable locator device to have the ability to also receive communications, the embodiments may involve a simple signal transmitting item. As noted earlier, known communication means are used to provide the signal sent by the person or persons trapped or otherwise in need of assistance. Obviously, if electricity is still available, hard-wired phones may be used if the device is a “furnishing”; however, this is very unlikely in any type of real disaster. Known communication means such as cellular telephones, computers and at least four signals of radio frequency, infrared, laser, fiber optics or other suitable communication may be used to provide the signal or signals. Any suitable communications means that will provide signals always continuously, and usually sequentially, but intermittently is also feasible, will be used in the present embodiments. Communication could take the form of voice, data, codes, images, light and other sounds. Many appropriate known communication means include those disclosed in U.S. Pat. No. 5,844,824.

There are known sources of energy such as those normally available at home including electricity, battery, fuel cell, oil, natural gas, etc. Also known are deferred action batteries that are activated when they contact water, other liquids or other means such as vibration, change in barometric pressure, and impact. Many such deferred action batteries or fuel cells are used in emergency kits by pilots who may be shot down or sailors who for one reason or another are stranded at sea. These deferred action batteries or fuel cells would be appropriate for use in the present invention.

If the walls or structure of a residence or work place, or attachments or enclosures therein and thereto, have the ability to transmit signals, when they collapse, they may still have this ability. This structural component can be also found in hotels, airports, hospitals, schools, transportation means, vehicles and prisons. This embodiment includes the integration of computing and communications and electronics with typical furnishings or appurtenances to provide an intelligent environment for the area surrounding these furnishings.

In an embodiment, a portable electronic locator device is provided which comprises a structure which continuously emits, sequentially or intermittently, one or more distinct communication signals. These signals provide information to others that indicates their own or a person's location; this device being a user-“available” or supported item and/or a furnishing of many types housing or attached to a transmitter, and having a plurality of activation means including manual or automatic activation. By “available” means as a component of their home, vehicle, office or other structures. This item is selected from the group consisting of a campus, a vehicle, a residence, an office, a wristwatch, pendants, cameras, personal mobile computers, cell phones, PDA's/EDA's, clothing, glasses and jewelry. The electronic device can be enabled to both send and optionally to receive communications. Energy supplied for said locator device is a member selected from and/or a combination from the group consisting of but not limited to: solar energy, body movement, motion energy generation, water activation, heat exchange, fuel cells and batteries. The electronic device may have a preprogrammed message that is enabled to facilitate sender location information including the name of person seeking assistance and/or the location and/or ID address of the furnishing or embodiment in connection with the user itself. The device may also contain medical and other personal information for the person. The electronic device is enabled to provide voice transmission from the sender if needed and/or applicable. The device is enabled to continuously emit a plurality of signals until it runs out of power, or receives an acknowledgement or handshake from a receiver, or is manually or automatically turned off. This device can be repowered and its memory will enable it to continue where it left off when it runs out of power. This embodiment includes forms for a standard commercial/consumer environment, and/or forms for a rugged environment; the electronic locator device comprising in an operative arrangement a transmitter enabled to emit a plurality of sequential signals, with manual or automatic device activation. It is enabled to convey a spontaneous or preprogrammed signal. The transmitter is adapted to communicate information to others that indicates the location of the sender or, in the case of a furnishing encompassing a transmitter that of the person the furnishing containing the transmitter is in connection with, by any communications means. The device is provided as a component in a member selected from the group consisting of a campus environment, a residence, a work place, a user supported item, vehicles, clothing, PDA's/EDA's and a mobile communication item. In addition to a cell phone or a computer, at least four communication signals as above noted are selected from the group consisting of AM radio, FM radio, RFs, cellular phones, XM radio, satellite line of site, microwave, sonar, Bluetooth, IEEE 802.11x communications means and infrared; said locator device may be preferably intrinsically safe and/or ruggedized or MILSPEC. This ruggedized and/or MILSPEC device has a water-resistant or waterproof housing and is shock resistant or shock-proof. It is important that this device has a housing resistant to a member selected from the group consisting of dirt, dust, oil, gas, chemicals, heat, cold, pressure changes and impact.

As above stated, the source of the distinct communication signals can be a user-available or supported item generally electronic, or a furnishing/appliance encompassing or having attached a transmitter. Some are worn or user supported while others are located in a user available location such as the integration of computing and communications electronics in campuses, residences or offices, furnishings, ceiling furnishings, floor furnishings and wall furnishings.

The furnishings encompassing such transmitters can be formed into a local area network and/or a wide area network; either by fixed location of such furnishings or by the formation of an ad hoc network, with an optional automatic hand-shaking, to determine each other's existence as part of the network. These furnishings have their own address information, location information and can be in communications contact with a user-supported emergency location transmitter on or in a person in proximity to the LAN and/or WAN. This LAN/WAN interacting with the person who has authority to control or interact with it, can in addition to serving as an emergency location service also offer many control services for that person in managing the environment housing it and the surrounding environs. Such control functions include but are not limited to: control of the area's security protection, lighting, entertainment devices, HVAC, meal preparation, laundry and house cleaning, and computing and communications services and means.

If a structure such as a campus, residence, office or work place, or entertainment place or recreation vehicle, medical or law enforcement facility should collapse during a disaster, chances are that the structure could still provide usable communication means or at least partial availability of these computer and communication means. In this disclosure and claims, the term “furnishings” shall include all of the below items of paragraphs 011-019.

“Intelligent Furnishings”—(Means throughout this disclosure and claims the items of paragraphs 011 and 012.) Here one would use in the embodiment as communication means the integration of computing and communications and/or electronics with typical furnishings and/or appurtenances to provide an intelligent environment for the area surrounding the intelligent furnishings. This intelligent environment will therefore provide computation and communications capabilities as well as data and information exchange capabilities in the general area surrounding such furnishings. Such communications and computing capabilities may also be utilized to provide an intelligent environment for a room or space around such furnishings

The areas that will encompass such an intelligent environment include but are not restricted to campuses, homes, offices, hotels, airports, military installations, hospitals, schools, trains, airplanes, ships, buses, commercial or recreational vehicles and prisons. The means of communication may be wired or wireless, line of sight, spread spectrum, microwave, RF, IR or other suitable means. The integration of communication can also be accomplished by having communication components built into textiles or plastics to create such furnishings. Obviously, these furnishings can automatically handshake with one another.

“Intelligent Ceiling Furnishings”—(Means throughout this disclosure and claims the items of paragraph 013 and 014). In this embodiment, one would use the integration of computing and communications and/or electronics with typical ceiling furnishings and/or appurtenances to provide an intelligent environment for the area surrounding the intelligent ceiling furnishings. This intelligent environment will therefore provide computation and communications capabilities as well as data and information exchange capabilities in the general area surrounding such furnishings. Typical ceiling furnishings will include but are not limited to light fixtures, cameras, fire, chemical, radiation and smoke detectors, murals, skylights, speakers and ventilation fixtures and vents.

The areas that will encompass such an intelligent environment include but are not restricted to campuses of all kinds, homes, offices, hotels, airports, military installations, hospitals, schools, trains, airplanes, ships, buses, commercial or recreational vehicles and prisons. The means of communication may be wired or wireless, line of sight, spread spectrum, RF, IR, microwave or any other means.

“Intelligent Textiles and Materials” (Means throughout this disclosure and claims the items of paragraph 011). This embodiment will also include the integration of such computing and communications components into conductive textiles and/or plastics to create such furnishings (intelligent and conductive textiles and materials).

“Intelligent Floor Furnishings”—(includes throughout this disclosure and claims the items of paragraph 012 and 013). In this embodiment, the available communication means would involve the integration of computing and communications and/or electronics with typical floor coverings and furnishings and/or appurtenances to provide an intelligent environment for the area surrounding the intelligent wall furnishings. This intelligent environment will therefore provide computation and communications capabilities as well as data and information exchange capabilities in the general area surrounding such furnishings. Typical floor furnishings will include but are not limited to carpeting, tiles, vinyl coverings, light fixtures, cameras, stair wells, “trim”, mats and rugs, drinking fountains, pools, fire and smoke detectors, murals, speakers and ventilation fixtures and vents.

The areas that will encompass such an intelligent environment include but are not restricted to campuses, homes, offices, hotels, airports, military installations, hospitals, schools, trains, airplanes, ships, buses, recreational vehicles and prisons. The means of communication may be wired or wireless, line of sight, spread spectrum, RF, IR, microwave or any other means. This embodiment also includes the integration of such computing and communications components into conductive textiles and/or plastics to create such furnishings (intelligent and conductive textiles and materials).

“Intelligent Wall Furnishings”—(Means throughout this disclosure and claims the items of paragraphs 018 and 019). In this embodiment, the available communication means would provide the integration of computing and communications and/or electronics with typical wall furnishings and/or appurtenances to provide an intelligent environment for the area surrounding the intelligent wall furnishings. This intelligent environment will therefore provide computation and communications capabilities as well as data and information exchange capabilities in the general area surrounding such furnishings. Typical wall furnishings will include but are not limited to paintings, wallpaper, wall “trim”, window and door frames, mirrors, light fixtures, camera, fire, chemical, radiation and smoke detectors, murals, ornaments, speakers, fans/air conditioning systems and ventilation fixtures and vents.

The areas that will encompass such an intelligent environment include but are not restricted to homes, offices, hotels, airports, military installations, hospitals, schools, trains, airplanes, ships, buses, commercial or recreational vehicles and prisons. The means of communication may be wired or wireless, line of sight, spread spectrum, RF, IR, microwave or any other means.

It will be appreciated that various of the above-disclosed and other features and functions, alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A portable electronic device which comprises a structure which continuously and/or intermittently emits sequentially several distinct communication signals that provide information to others that indicates a sender's and/or a furnishing's location and/or other personal information;
said device being either a user-available or supported item and/or a “furnishing” embodying such a capability, and
having a plurality of activation means including manual or automatic activation, where said communication signals in addition to a cell phone and/or a computer are at least four signals emitted from a member selected from the group consisting of AM and FM radio, RF, microwave, cellular phones, XM radio, satellite line of site, sonar, Bluetooth, laser fiber optics, IEEE 802.11 communications standards means, infrared means and others.

2. The electronic locator device of claim 1 wherein said item is selected from the group consisting of a campus, a residence, an office, a vehicle, a wristwatch, pendants, cameras, personal mobile computers, cell phones, PDA's/EDA's, clothing, medical implants, glasses and jewelry.

3. The electronic locator device of claim 1 wherein said device is enabled to both send and receive said communication signals communications, and said device is enabled to manually or automatically be turned on or off.

4. The device of claim 1 wherein all available signals are continuously non-stop emitted during activation.

5. The electronic locator of claim 1 where energy supplied for said locator device is in addition to standard electricity a member selected from the group consisting of solar energy, body movement, motion energy generation, water activation, heat exchange, fuel cells and batteries.

6. The electronic device of claim 1 having a preprogrammed message or signal that is enabled to continuously facilitate sender location information including the name and location of the person seeking assistance, or the location and address of the furnishing hosting such a capability in communication with the person.

7. The electronic device of claim 1 enabled to provide voice transmission of the sender and/or to receive analog or digital voice commands

8. The electronic device of claim 1 whereby the device is enabled to continuously emit signals until it loses power or receives an acknowledgement or handshake from a receiver, or when said device is repowered after it loses power.

9. An electronic locator device comprising in an operative arrangement
a transmitter from an electronics location enabled to emit/receive a plurality of sequential signals,
having manual or automatic device activation and enabled to convey at least one spontaneous or preprogrammed signal from/to said electronics location,
said transmitter adapted to communicate information to others that indicates a location and/or other desired information,
said device being provided as a component in a member selected from the group consisting of a campus, a residence, a school, a hospital, a work place, a vehicle, a user supported item, vehicles, clothing, PDA's/EDA's and a mobile communication item,
said communication signals in addition to a cell phone and computer is selected from at least four signals from the group consisting of AM radio, FM radio, RF, microwave, XM radio, satellite line of site, sonar, Bluetooth, laser, fiber optics, IEEE 802.11x and Infrared communications devices, said locator device being intrinsically safe.

10. The locator device of claim 9 wherein said device is enabled to both send and receive said signals and communication and said device is enabled to manually or automatically be turned on or off.

11. The locator device of claim 9 where energy supplied for said locator device, in addition to hard-wire electricity is a member selected from the group consisting of motion energy, solar energy, water activation, heat exchange, fuel cells and batteries.

12. The device of claim 9 having a waterproof and shock resistant housing.

13. The device of claim 9 having a housing resistance to a member selected from the group consisting of dirt, dust, oil, gas, chemical, heat, cold, pressure change and/or impact.

14. The locator device of claim 9 capable of emitting several distinct electronic signals comprising an electronics source location selected from the group consisting of intelligent furnishings, intelligent ceiling furnishings, intelligent floor furnishings, intelligent wall furnishings, and mixtures thereof.

15. The device of claim 9 wherein said electronics location is provided in intelligent furnishings.

16. The device of claim 9 wherein said electronics location is provided in intelligent ceiling furnishings.

17. The device of claim 9 wherein said electronics location is provided in intelligent clothing, floor or wall furnishings.

18. An electronic emergency locator device configured for use in an emergency rescue operation, said device comprising in an operative arrangement:
a transmitter from an electronics location enabled to continuously or intermittently emit/receive in addition to cell phones and computers at least four different signals, said device having manual or automatic device activation and enabled to convey a spontaneous or preprogrammed emergency signal or signals from/to said electronics location;
said transmitter adapted to communicate in addition to cell phones and computers at least four different signals and information to others that indicates information including a location of a trapped person;
said at least four different signals selected from the group consisting of AM radio, FM radio, XM radio, RF, microwave, radio, satellite line of site, sonar, Bluetooth, laser, fiber optics, IEEE 802.11x and Infrared communications devices, said locator device being substantially intrinsically safe;
said preprogrammed signal comprising a preprogrammed emergency message comprising sender location, sender name, sender medical information, sender address, and other relevant information;
said signals in the form of voice, code images, light, and other audio means;
said electronic locator device comprising a ruggedized, waterproof and shock resistant housing that is resistant to members selected from the group consisting of dirt, dust, oil, gas, chemical, heat, cold, pressure change and/or impact;
said signals comprise in the form of voice, code images, light and other audio means.

19. An electronic emergency locator device adapted for use in an emergency rescue operation, said device comprising in an operative arrangement:
a transmitter from an electronics location enabled to continuously or intermittently emit/receive a plurality of different sequential signals, said device having manual or automatic device activation and enabled to convey a spontaneous or pre-programmed emergency signal or signals from/to said electronics location;
said transmitter adapted to communicate a plurality of different signals and information to others that indicates information, including a location of a trapped person;
said plurality of different signals are at least four different signals in addition to cell phones and computers that are selected from the group consisting of AM radio, FM radio, XM radio, RF, microwave, radio, satellite line of site, sonar, Bluetooth, laser, fiber optics, IEEE 802.11x and Infrared communications devices, said locator device being substantially intrinsically safe;
said pre-programmed signal comprising a pre-programmed emergency message comprising sender location, sender name, sender medical information and sender address;
energy supplied to said locator device is provided in addition to hard wire electricity or a battery by a member selected from the group consisting of body movement, motion energy generation, water activation, heat exchange and fuel cells;
said electronic locator device comprising a ruggedized, waterproof and shock resistant housing that is resistant to members selected from the group consisting of dirt, dust, oil, gas, chemicals, heat, cold, pressure change or impact;
said signals in the form of voice, code images, light and other audio means.
